(19) United States
(12) Patent Application Publication
(10) Pub. No.: US 2015/0121095 A1
(43) Pub. Date: Apr. 30, 2015

(54) HUB DEVICE FOR UNIVERSAL SERIAL BUS AND POWER MANAGEMENT METHOD THEREOF

(71) Applicant: Acer Incorporated, New Taipei City (TW)

(72) Inventors: Meng-Chieh Tsai, New Taipei City (TW); Po-Yu Li, New Taipei City (TW); Kuan-Chi Juan, New Taipei City (TW); Che-Wei Lin, New Taipei City (TW)

(73) Assignee: Acer Incorporated, New Taipei City (TW)

(21) Appl. No.: 14/181,744

(22) Filed: Feb. 17, 2014

(30) Foreign Application Priority Data
Oct. 31, 2013 (TW) 102139586

(51) Int. Cl. G06F 1/26

(52) U.S. Cl. CPC G06F 1/266
USPC 713/310

(57) ABSTRACT

A hub apparatus for USB and a power management method thereof are provided. The hub apparatus includes at least one USB-PD port, at least one USB port and a control unit. The control unit detects whether the USB-PD port is connected to a first external device and whether the USB port is contacted to a second external device respectively. When the at least one first external device complies with a USB-PD interface and a connecting situation of the at least one first external device and the at least one second external device are changed, the control unit determines a required power supply determination value according to the connecting situation of the at least one first external device and the at least one second external device, and accordingly, the control unit communicates with the first external device to set a power transmission profile of the at least one USB-PD port.

### CROSS-REFERENCE TO RELATED APPLICATION

This application claims the priority benefit of Taiwan application serial no. 102139586, filed on Oct. 31, 2013. The entirety of the above-mentioned patent application is hereby incorporated by reference herein and made a part of this specification.

### BACKGROUND

1. Technical Field

The invention relates to a universal serial bus technique. Particularly, the invention relates to a hub device for universal serial bus that is capable of dynamically adjusting a power transmission profile of a USB-PD interface of an external device and a power management method thereof.

2. Related Art

Universal serial bus (USB) interfaces are widely applied in electronic devices such as mobile phones, digital cameras, tablet computers, etc. Besides that the USB interface can be used to transmit data, in recent years, a power transmission function thereof is further developed. Due to booming development of the USB interface, a plurality of mobile devices use the USB interface or a Micro USB interface to achieve dual functions of data transmission and power transmission, and use the same to replace the conventional power transmission interface.

However, due to a standard limitation and a hardware limitation of the USB interface, the power transmission function of the USB interface is weak, which can only supply power to small electronic devices. If the USB interface is used to supply power to products having a large power consumption (for example, a screen display or a notebook computer), it may take a long time to achieve the demand. Therefore, a USB-power delivery (PD) interface specified for power transmission and data transmission is developed, and devices adapted to the USB-PD interface can be configured with different maximum power profiles.

Since the USB interface is convenient in data transmission, hubs and other related products used for integrating diverse USB interfaces are developed. However, the hub having the USB interface can still only manage the data transmission function, and cannot manage the power transmission function of the USB interface. Therefore, a better power management method is required to be developed for the hub equipment having the USB interface.

### SUMMARY

The invention is directed to a hub device for universal serial bus (USB) and a power management method thereof, which are capable of detecting connecting situations between connecting ports and external devices, and setting suitable power profiles for the external devices by using a USB-power delivery (PD) interface. In this way, the hub device is capable of dynamically adjusting a power transmission profile when the connecting situation of each connecting port is changed, so as to implement efficient power management and distribution.

The invention provides a hub device for universal serial bus (USB). The hub device includes at least one USB-power delivery (PD) port, at least one USB port and a control unit. The control unit is coupled to the at least one USB-PD port and the at least one USB port. The control unit detects whether the at least one USB-PD port is connected to a first external device and whether the at least one USB port is connected to a second external device. When the first external device is complied with a USB-PD interface and a connecting situation of the first external device and the second external device is changed, the control unit determines a required power supply determination value according to the connecting situation of the first external device and the second external device, and communicates with the first external device to set a power transmission profile of the at least one USB-PD port according to the power supply determination value.

In an embodiment of the invention, the control unit respectively provides power according to a device type of the first external device and receives power according to a device type of the second external device.

In an embodiment of the invention, the power transmission profile of the at least one USB-PD port includes a plurality of power profiles respectively corresponding to different maximum supply powers, and the control unit selects one of the power profiles according to the power supply determination value, and notifies the selected power profile to the first external device.

In an embodiment of the invention, the first external device is a power supply device or a power receiving device complying with the USB-PD interface, and the second external device is a power supply device or a power receiving device complying with a USB protocol.

In an embodiment of the invention, the power supply device includes a power adapter.

According to another aspect, the invention provides a power management method of a hub device for USB, which includes following steps. It is detected whether at least one USB-PD port is connected to a first external device and whether at least one USB port is connected to a second external device, where the hub device for USB includes the at least one USB-PD port and the at least one USB port. When the first external device is complied with a USB-PD interface and a connecting situation of the first external device and the second external device is changed, a power supply determination value required by the hub device is determined according to the connecting situation of the first external device and the second external device. The first external device dynamically sets a power transmission profile of the at least one USB-PD port.

In an embodiment of the invention, the power management method further includes a following step. When the first external device is not complied with the USB-PD interface, a communication operation complying with a USB protocol is performed.

In an embodiment of the invention, the power management method further includes a following step. Power is supplied according to a device type of the first external device and power is received according to a device type of the second external device.

In an embodiment of the invention, the power management method further includes a following step. A power supply value provided by each of the at least one USB port is dynamically adjusted according to an input power provided by the at least one USB-PD port.

In an embodiment of the invention, the power transmission profile of the at least one USB-PD port includes a plurality of power profiles respectively corresponding to different maximum supply powers. And, the step of setting the power transmission profile of the at least one USB-PD port includes following steps. One of the power profiles is selected according to the power supply determination value, and the selected power profile is notified to the first external device.

According to the above descriptions, the hub device of the invention is capable of communicating with the first external device complying with the USB-PD interface by using the USB-PD port to obtain an applicable USB-PD power profile thereof, and setting a power profile of the first external device for power transmission through the USB-PD interface according to the required maximum power of the external devices connected to the hub device. In this way, the hub device of the invention is capable of dynamically adjusting the power transmission profile when the connecting situation of the connecting ports is changed, so as to implement efficient power management and distribution.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a hub device for universal serial bus (USB) according to an embodiment of the invention.

FIG. 2 is a flowchart illustrating a power management method of a hub device for USB according to an embodiment of the invention.

### DETAILED DESCRIPTION OF DISCLOSED EMBODIMENTS

In order to achieve an effect that a hub device dynamically adjusts a power transmission profile of a universal serial bus-power delivery (USB-PD) port thereof, an embodiment of the invention provides a hub device for USB and a power management method thereof. The hub device respectively detects connecting situations of the USB-PD port and a USB port with external devices, and dynamically adjusts the power transmission profile of the USB-PD port according to the connecting situations. In this way, the hub device can dynamically determine and set the power transmission profile of a USB-PD interface according to power consumption of the external devices, so as to properly perform power management and reduce the power consumption. A plurality of embodiments coping with the spirit of the invention are provided below for reference, though the scope of the invention is not limited to the following embodiments.

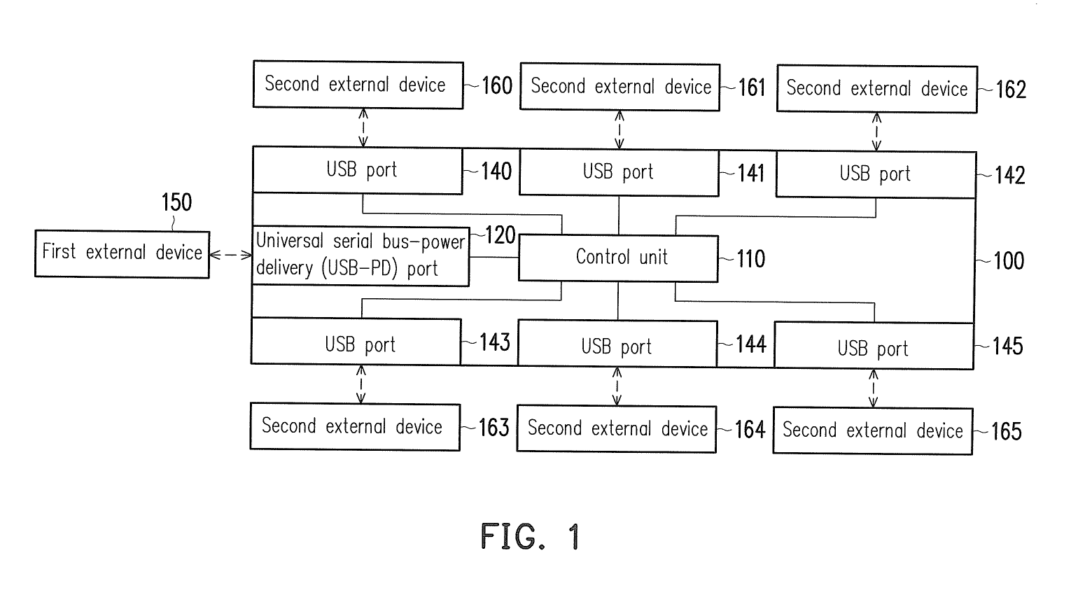

FIG. 1 is a functional block diagram of a hub device 100 for USB according to an embodiment of the invention. Referring to FIG. 1, the hub device 100 includes a control unit 110, one or a plurality of USB-PD ports and one or a plurality of USB ports. In FIG. 1, the hub device 100 has one USB-PD port 120 and six USB ports 140-145, and those skilled in the art can arbitrarily adjust numbers of the USB-PD ports 120 and the USB ports 140-145 according to an actual requirement. For example, a hub device coping with the other embodiment may also have two or more than two USB-PD ports. In the present embodiment, the USB-PD port 120 is complied with related profiles of a USB-PD interface, for example, corresponding physical profiles of having physical pins capable of detecting whether a first external device 150 is complied with the USB-PD interface, or having internal data transmission bus (VBUS) with six pins, etc.

The control unit 110 is coupled to the USB-PD port 120 and the USB ports 140-145, and determines whether the hub device 100 is connected to external devices 150, 160-165 through the above ports. The control unit 110 can be a system chip, a microprocessor, a micro control unit (MCU) or an integrated circuit that has a computing function. The control unit 110 of the present embodiment is used for processing operations related to data transmission and power management of the hub device 100 on related interfaces such as USB, USB battery charging (BC) 1.2, USB-PD, etc. In other words, the control unit 110 can communicate with the external devices complying with an USB interface (for example, USB 1.0, 2.0, 3.0), a USB battery charging (BC) interface (for example, USB BC 1.2) and/or the USB-PD interface through the corresponding USB ports. The control unit 110 can detect the device connected to any one of the USB ports 140-145 as one of a standard downstream port (SDP), a charging downstream port (CDP) and a dedicated charging port (DCP), and the control unit 110 can manage the power transmitted/supplied by the USB ports 140-145 according to a general USB standard or a USB BC standard.

In the present embodiment, the USB-PD port 120 is a transmission port complying with the USB-PD interface. Under a profile of the USB-PD interface, the first external device 150 complying with the USB-PD interface may provide a plurality of different power transmission profiles (referring to a table (1) for details). Compared to the USB 2.0 interface that provides a maximum power of 2.5 walts (W) and the USB 3.0 interface that provides the maximum power of 4.5 W, the USB-PD interface may provide the maximum power of 10 W, 18 W, 36 W, 60 W and 100 W, etc., such that the first external device 150 having the USB-PD interface may providing larger supply power, so as to meet a power requirement of today's diverse electronic products.

TABLE 1

| | | | |
|---|---|---|---|
| | | | Maximum supply |
| Profile | Voltage | Current | power |

| | | | |
|---|---|---|---|
| Profile 0 | Customized | Customized | Customized |

| | | | | | | |
|---|---|---|---|---|---|---|
| Profile 1 | 5 | V | 2 | A | 10 | W |
| Profile 2 | 5 | V | 2 | A | 18 | W |
| | 12 | V | 1.5 | A | | |
| Profile 3 | 5 | V | 2 | A | 36 | W |
| | 12 | V | 3 | A | | |
| Profile 4 | 5 | V | 2 | A | 60 | W |
| | 12 | V | 3 | A | | |
| | 20 | V | 3 | A | | |
| Profile 5 | 5 | V | 2 | A | 100 | W |
| | 12 | V | 5 | A | | |
| | 20 | V | 5 | A | | |

The above profiles 1-5 are predetermined profiles of the USB-PD interface, and the profile 0 can be customized by a manufacturer. In this way, in the present embodiment, when the first external device 150 is connected to the hub device 100 through the USB-PD port 120, the control unit 110 may determine whether the first external device 150 is complied with the profile of the USB-PD interface through a specific pin on the USB-PD port 120. When the first external device 150 is complied with the profile of the USB-PD interface, the control unit 110 can communicate with the first external device 150, and the first external device 150 notifies the profile corresponding to the USB-PD interface to the control unit 110. Then, the control unit 110 estimates a possible maximum power consumption according to the second external devices 160-165 connected to the hub device 100, and accordingly sets a profile of the USB-PD interface or a customized profile of the first external device 150, such that the hub device 100 transmits/receives a corresponding power to/from the first external device 150 through the USB-PD interface, which is described in detail below.

In the present embodiment, the external devices 150, 160-165 are divided into two types of power supply devices and power receiving devices. The so-called “power supply device” is intermediate equipment connected to other power supply sources (for example, supply mains, mobile power), for example, a power adapter. The hub device 100 obtains power through the power supply device, and provides the power to other power receiving devices connected to the hub device 100. The so-called “power receiving device” is an electronic product capable of consuming power and required to be charged, for example, a mobile phone, and a tablet computer, etc. Therefore, in the present embodiment, the user can connect the power adapter complying with the USB interface or the USB-PD interface to the USB ports 140-145 or the USB-PD port 120, and connect the external devices required to be charged to the corresponding connecting ports. In this way, power transmission and management can be implemented through the hub device 100. The user can connect the external devices to the hub device 100 through a more flexible approach, and provide a more suitable power to the connected external devices.

The power management method of the hub device for USB of the present invention is described in detail below, by which the hub device 100 can dynamically adjust the power configuration according to a connecting situation of the external devices, so as to enhance effectiveness for supplying power.

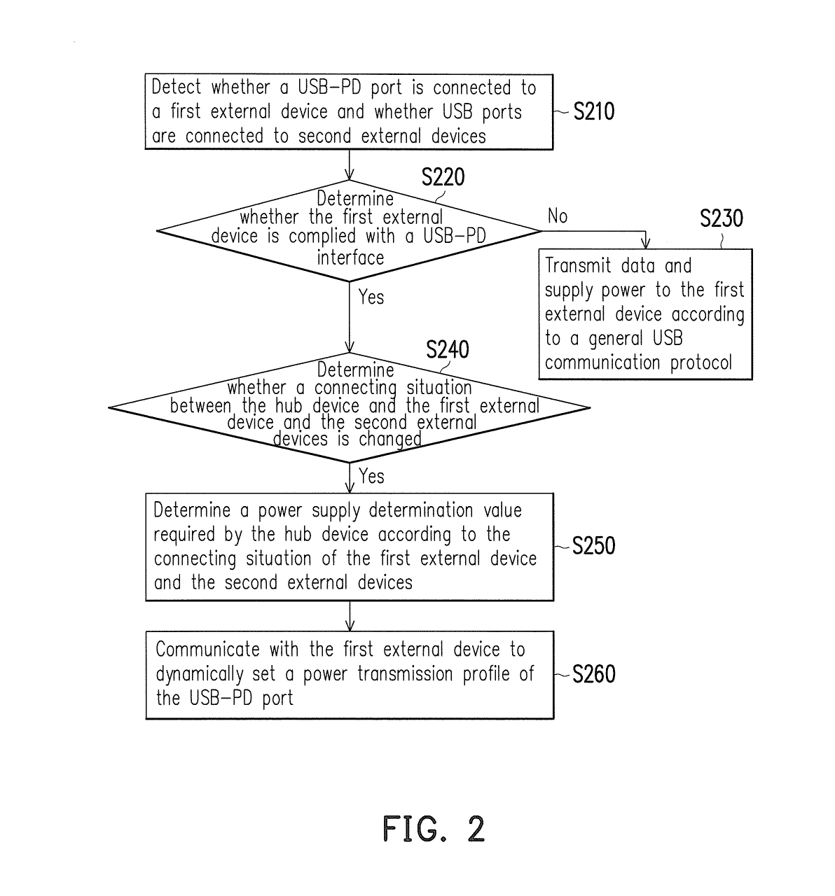

FIG. 2 is a flowchart illustrating a power management method of a hub device for USB according to an embodiment of the invention. Referring to FIG. 2, in step S210, the control unit 110 detects whether the USB-PD port 120 is connected to the first external device 150 and whether the USB ports 140-145 are connected to the second external devices 160-165. In detail, the control unit 110 can determine whether the first external device 150 is connected to the hub device 100 through the specific pin of the USB-PD port 120. The control unit 110 can determine whether the second external device is plugged in according to a potential difference of a power pin (i.e. D+ and D−) of the USB-PD port 120.

When it is determined that the first external device 150 is plugged in, in step S220, the control unit 110 determines whether the first external device 150 is complied with the USB-PD interface. If the first external device 150 is not complied with the USB-PD interface but is only complied with the USB interface, data is transmitted to and power is supplied to the first external device 150 according to a general USB communication protocol (step 230). If the first external device 150 is complied with the USB-PD interface, the control unit 110 can communicate with the first external device 150 according to related protocol of the USB-PD interface, so as to learn the profile of the USB-PD interface supported by the first external device 150 (for example, the specified profiles 1-5 or the specifically customized profile 0, where the profile information includes supported power voltage value and current value).

Then, in step S240, the control unit 110 determines whether a connecting situation between the hub device 100 and the first external device 150 and the second external devices 160-165 is changed. The so-called “change of the connecting situation between the hub device 100 and the first external device 150, the second external devices 160-165” refers to that the control unit 110 determines whether other first external device 150 or the second external devices 160-165 are plugged into the hub device 100, or whether the first external device 150 and the second external devices 160-165 are unplugged from the hub device 100, such that the connecting situation of the hub device 100 is changed. Besides plugging/unplugging the external device, the above connecting situation can also be a connecting situation of the hub device 100 after first booting. If the above connecting situation is changed, step S250 is executed, by which the control unit 110 determines a power supply determination value required by the hub device 100 according to the connecting situation of the first external device 150 and the second external devices 160-165.

In detail, referring to the table (1), the five profiles listed in the table (1) all have the corresponding maximum power supply values, and the control unit 110 takes the above five maximum power supply values as the power supply determination values. The control unit 110 communicates with the first external device 150 according to the communication protocol of the USB interface to learn the profiles supported by the first external device 150, and it is assumed that the first external device 150 can support the profiles 1-5 in the table (1). Then, the control unit 110 learns a current connecting situation of the second external devices 160-165 to obtain a current power supplying situation, and calculates the power required by the first external device 150 and the second external devices 160-165. Thereafter, the control unit 110 determines the profile of the USB-PD interface of the first external device 150 that is complied with the currently required power according to the power supply determination value, so as to obtain the best power transmission profile for the currently required power.

In step S260, the control unit 110 communicates with the first external device 150 to dynamically set a power transmission profile of the USB-PD port 120 according to the power supply determination value.

Descriptions are made with reference of embodiments. Referring to FIG. 1 and FIG. 2, the control unit 110 detects whether the external devices 150 and 160-165 are plugged in, and determines whether the external devices 150 and 160-165 are power supply devices or power receiving devices when detecting that the external devices are plugged in. If the first external device 150 is the power supply device, and the external devices 160-165 are all connected power receiving devices, the control unit 110 determines a maximum power requirement of the USB interface corresponding to the power receiving devices in the step S250, so as to calculate the power supply determination value. Namely, when the connected second external devices 160-165 are all the power receiving devices of the USB interface, the control unit 110 estimates the power supply determination value to be six times of the maximum power supply value (10 W) of the USB interface, i.e. a total power of 60 W is required for supplying to the second external devices 160-165. Therefore, the control unit 110 communicates with the first external device 150 to set the profile of the USB-PD interface thereof to be the profile 4 or the profile 5 of the table (1), so as to satisfy the power consumption requirement. Comparatively, when the first external device 150 is the power receiving device, and the second external devices 160-165 are all power supply devices, since each USB interface can only provide the power of 10 W, the control unit 110 can communicate with the first external device 150 to decrease the profile of the USB-PD interface thereof to the profiles 1-4 in the table (1), so as to satisfy the power consumption requirement of the first external device 150. If the first external device 150 is set to the profile 4, since the maximum power of the profile 4 is 36 W, which is greater than and close to 30 W, not only the power consumption requirement of the hub device 100 is satisfied, consumption in power conversion is also saved.

Certainly, the first external device 150 can be the power supply device, the second external device 160 can also be the power supply device, the second external devices 161-164 are power receiving devices, and the second external device 165 is not connected to the hub device 100. In this way, the control unit 110 can pre-estimate the power supply determination value, and a calculation method thereof is to subtract a power supply amount of 1×10 W from a power consumption amount of 4×10 W to obtain 30 W. Therefore, the control unit 110 can communicate with the first external device 150 to decrease the profile of the USB-PD interface thereof to any one of the profiles 3-6 in the table (1), so as to satisfy the power consumption requirement.

In summary, the hub device of the invention can communicate with the first external device complying with the USB-PD interface by using the USB-PD port to obtain an applicable USB-PD power profile thereof, and set a power profile of the first external device for power transmission through the USB-PD interface according to the required maximum power of the external devices connected to the hub device. In this way, the hub device of the invention is capable of dynamically adjusting the power transmission profile when the connecting situation of the connecting ports is changed, so as to implement efficient power management and distribution.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A hub device for universal serial bus (USB), comprising:
at least one USB-power delivery (PD) port;
at least one USB port; and
a control unit, coupled to the at least one USB-PD port and the at least one USB port,
wherein the control unit detects whether the at least one USB-PD port is connected to a first external device and whether the at least one USB port is connected to a second external device,
when the first external device is complied with a USB-PD interface and a connecting situation of the first external device and the second external device is changed, the control unit determines a required power supply determination value according to the connecting situation of the first external device and the second external device, and communicates with the first external device to set a power transmission profile of the at least one USB-PD port according to the power supply determination value.

2. The hub device for USB as claimed in claim 1, wherein the control unit respectively provides power according to a device type of the first external device and receives power according to a device type of the second external device.

3. The hub device for USB as claimed in claim 1, wherein the power transmission profile of the at least one USB-PD port comprises a plurality of power profiles respectively corresponding to different maximum supply powers, and the control unit selects one of the power profiles according to the power supply determination value, and notifies the selected power profile to the first external device.

4. The hub device for USB as claimed in claim 1, wherein the first external device is a power supply device or a power receiving device complying with the USB-PD interface, and the second external device is a power supply device or a power receiving device complying with a USB protocol.

5. The hub device for USB as claimed in claim 4, wherein the power supply device comprises a power adapter.

6. A power management method of a hub device for USB, comprising:
detecting whether at least one USB-PD port is connected to a first external device and whether at least one USB port is connected to a second external device, wherein the hub device for USB comprises the at least one USB-PD port and the at least one USB port;
determining a power supply determination value required by the hub device according to a connecting situation of the first external device and the second external device when the first external device is complied with a USB-PD interface and the connecting situation of the first external device and the second external device is changed; and
communicating with the first external device to dynamically set a power transmission profile of the at least one USB-PD port.

7. The power management method as claimed in claim 6, further comprising:
performing a communication operation complying with a USB protocol when the first external device is not complied with the USB-PD interface.

8. The power management method as claimed in claim 6, further comprising:
supplying power according to a device type of the first external device and receiving power according to a device type of the second external device.

9. The power management method as claimed in claim 6, further comprising:
dynamically adjusting a power supply value provided by each of the at least one USB port according to an input power provided by the at least one USB-PD port.

10. The power management method as claimed in claim 6, wherein the power transmission profile of the at least one USB-PD port comprises a plurality of power profiles respectively corresponding to different maximum supply powers, and
the step of setting the power transmission profile of the at least one USB-PD port comprises:
selecting one of the power profiles according to the power supply determination value, and notifying the selected power profile to the first external device.
